(19) United States
(12) Patent Application Publication
(10) Pub. No.: US 2014/0198501 A1
(43) Pub. Date: Jul. 17, 2014

(54) LIGHTING BASE OF THE LED LAMP AND ITS STAMPING MOLD

(71) Applicant: Yao-Huang Lin, New Taipei City (TW)

(72) Inventor: Yao-Huang Lin, New Taipei City (TW)

(21) Appl. No.: 13/744,314

(22) Filed: Jan. 17, 2013

(51) Int. Cl. F21V 23/00

(52) U.S. Cl. CPC F21V 23/00
USPC 362/249.02; 362/382

(57) ABSTRACT

The present invention provides the LED Lamp a new lighting base and its stamped molds to prevent the LED Lamp from electric leakage problems caused by the circuit board's loosening and damage from long continued use.

The present invention's technical method is that the top surface of the lighting base is surrounded with several axial-protruding raised pillars, with a circuit board placed on the top of the lighting base. This circuit board is equipped with vents that can fit tightly with the raised pillars, and the raised pillars can fit tightly with the openings after being squeezed from stamping through the mold, preventing the circuit board from loosening from said lighting base.

### FIELD OF THE INVENTION

This present invention relates to the light base of an LED Lamp and its stamping mold.

### BACKGROUND OF THE INVENTION

In recent years, the market for the LED Lamp has been expanding rapidly, with the LED Lamps' luminous efficiency improving the cost for the average lumen output decreasing, expanding the LED Lamps' application field to not only be holding lead roles in portable back-lighted equipment and large monitors in gyms, but also infiltrating the markets for cars & General Lighting, making its development very promising. As a result, more and more business dealers have begun involve into the market of the LED Lamp, improving the LED Lamp's development day by day.

However, the holding method for the old LED lamp's circuit board is by using screw-locking to fix the circuit board on a base. Technical documents on this matter can be referenced in Taiwan Patent No. TW-M440410 “A Lamp that can increase its thermolysis effect” (published in Nov. 1, 2012). It is a lamp that can increase its thermolysis effect and is described as follows:

Lamp Model: hollow-shaped with an opening, along with an added joint of the upper cover, built on the tip, so that the interior of the lamp becomes a sealed chamber. The chamber has a wicking structure built on all its walls, with liquids injected in the interior.

Lighting Module: A circuit board with LED parts built on the holding base of the LED lamp with the purpose of propelling light.

The problem of this disclosure is that the circuit board inside the lamp is screw-locked on the holding base of the LED lamp. Therefore, a screw strip might occur when the screw is overtighten, than resulting in the circuit hoard to loosen and cause problems like electric leakage.

In response, how to avoid the circuit hoard inside an LED Lamp causing problems like electric leakage due to loosening of said circuit board after long time using, has become the main problem that this present invention is to improve.

### SUMMARY OF THE INVENTION

There are two technical methods applied to this invention for solving aforementioned question:

First Technical Method:

A lighting base of an LED Lamp is characterized that:

The top surface of the lighting base is surrounded with several axial-protruding raised pillars, with a circuit board placed on the top of the lighting base. This circuit board is equipped with vents that can fit tightly with said raised pillars, and the raised pillars can fit tightly with the openings after being squeezed from stamping through the mold, preventing the circuit board from loosening and detached from said lighting base.

Said circuit board is inserted with at least one or more Light-Emitting Diodes that are electrically connected with it.

Said raised pillars are placed on the top surface of the lighting base, which are and formed inone piece and detachable from said lighting base.

The top surface of said lighting base has holes corresponding to said detachable raised pillars.

Second Technical Method:

A mold used for stamping LED Lamps' lighting bases that is suitable with said LED Lamp's lighting base, which is comprised:
A Top Mold part;
A Bottom Mold part;

Said top mold part has one side that coordinates with said raised pillars' part comprises mold cores that can stamp the raised pillars. The mold cores also has fillisters at the bottom.

Said bottom mold part can coordinate with the Top Mold part to store said lighting base.

Said mold used for stamping LED Lamps' lighting bases is characterized in that: the shape of the fillister can be either one of the following: a triangle, a polygon, or a cross.

### EFFECTS

1. This invention can hold the circuit board (2) on the lighting base (1) through the coordination of the circuit board's (2) vents (21) and the lighting base's (1) raised pillars (11). Then the Top Mold part (31)'s mold cores (33) would stamp the raised pillars (11), forcing the raised pillars (11) to coarctate the vents (21) from the side and bringing the raised pillars and the vents closely together, preventing the circuit board from causing electric leakage from loosening and damage due to continued use.

2. In this invention, the shape of mold cores' (33) fillisters (331) can be one of the following: a triangle, a polygon, or a cross, diversifying the applications of the new model while forming different product segmentations to expand the business dealers' market.

### BRIEF DESCRIPTION OF DRAWINGS

FIG. 1: A 3-D diagram of the invention's lighting base matching with an LED Lamp.

FIG. 2: A exploded view of the lighting base of present invention.

FIG. 3: A 3-D diagram of present invention, for showing the raised pillars as

detachable from the lighting base.

FIG. 4: A cutaway diagram of FIG. 3A-A.

FIG. 5: A exploded view of present invention for showing the raised pillars as detachable from the lighting base.

FIGS. 6 & 7: cutaway motion diagrams depicting the invention's lighting base matching up with the mold.

FIGS. 8˜10: 3-D diagrams showing the various shapes of the invention's mold core's fillisters.

### DETAILED DESCRIPTION OF PREFERRED EMBODIMENT

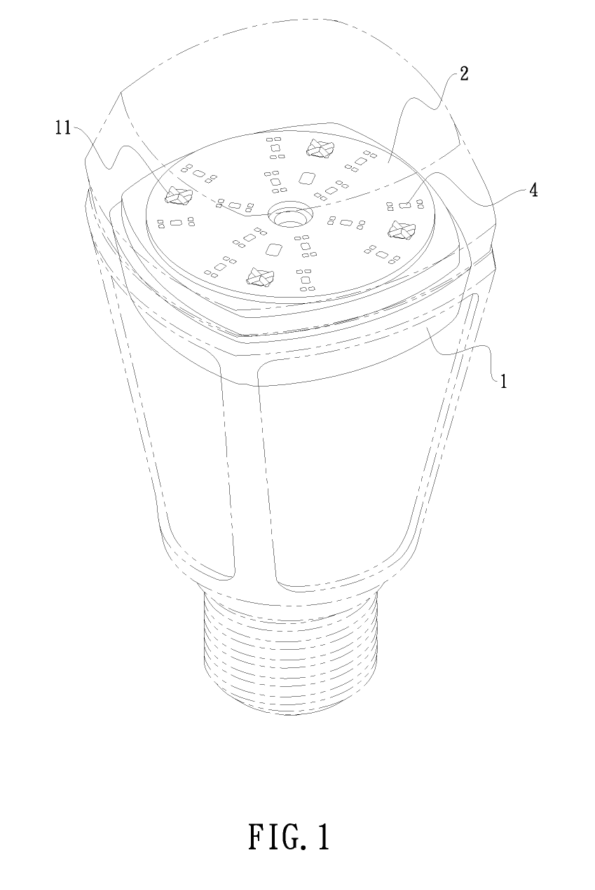

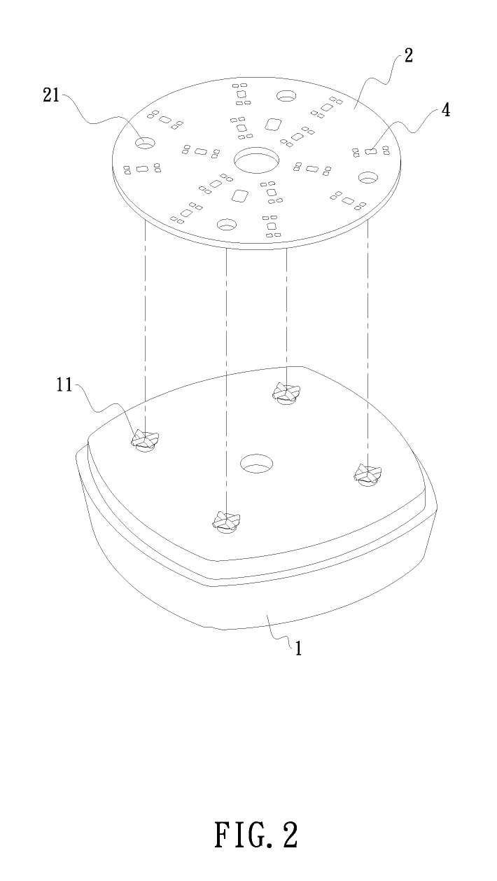

The following is a detailed description of the preferred embodiment: As shown in FIG. 1 is the 3-D diagram of the invention's lighting base matching with a LED Lamp, and as shown in FIG. 2 is a exploded view of the invention's lighting base.

The figures reveal the features of a LED Lamp's lighting base as follows:

The top surface of the lighting base (1) is surrounded with several axial-protruding raised pillars (11), with a circuit board (2) placed on the top of the lighting base (1). This circuit board (1) is equipped with vents (21) that can fit tightly with the raised pillars (11), and the raised pillars (11) can fit tightly with the vents (21) after being squeezed from stamping through the mold (3), preventing the circuit board (2) from loosening and detached from the lighting base (1) as foresaid.

Also, a feature from said LED Lamp's lighting base (1) is: said circuit board (2) is inserted with at least one or more Light-Emitting Diodes (4) that are electrically connected with said circuit board (2).

The circuit board (2) can be fixed tightly on the lighting base (1) through the coordination of the circuit board's (2) vents (21) and the lighting base's (1) raised pillars (11). Then the Top Mold part (31)'s mold cores (33) would stamp the raised pillars (11), forcing the raised pillars (11) to coarctate the vents (21) from the side and bringing the raised pillars and the vents closely together, preventing the circuit board from causing electric leakage from loosening and damage due to continuing use.

In addition, use the lighting base (1) to separate the circuit board (2) and the power source conversion unit (not depicted in the figures), because the circuit board (2) can also produce heat when operating. But the circuit board (2) has a high temperature heat-resistance, and if not separated, the heat produced from the circuit, board (2) would be concentrated in the interior, affecting the LED enough to cause luminous decay. Thus, the use of the lighting base (1) can prevent the problem of the LED's high malfunction rate due to the heat produced from both the circuit board (2) and the power source conversion unit (not depicted in the figures) to mix together and concentrated and resulting in the LED unable to cool down.

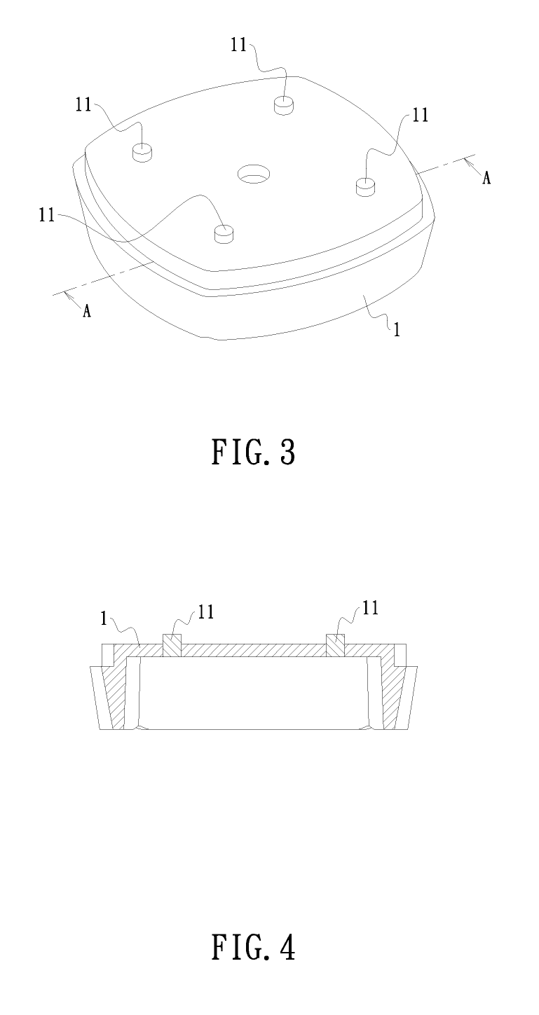

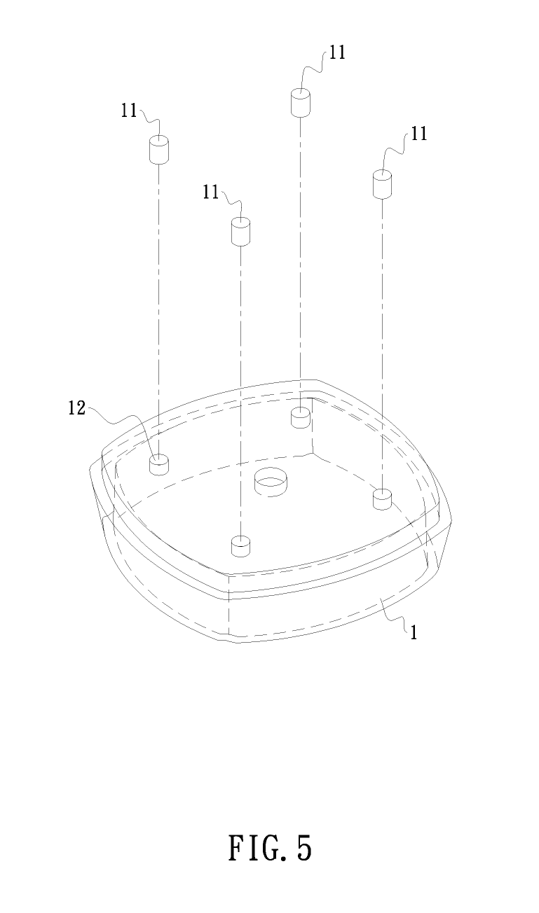

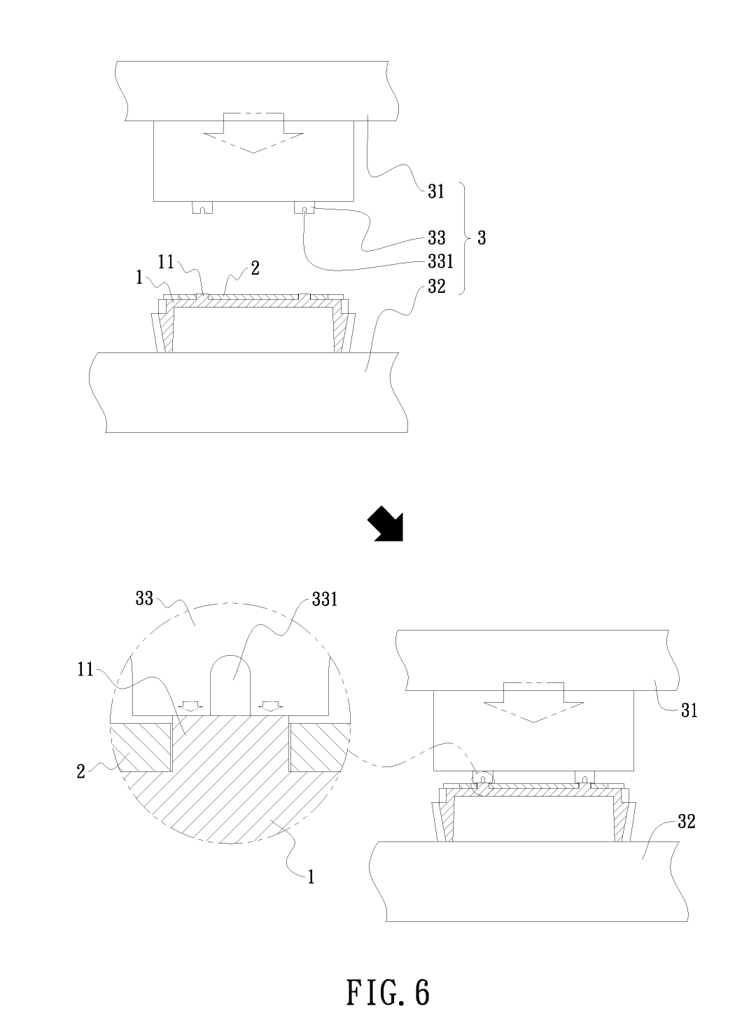

As shown in FIG. 3 is a 3-D diagram of present invention for showing the raised pillars as detachable from the lighting base. As shown in FIG. 4 is a cutaway diagram of FIG. 3A-A, while FIG. 5 is a exploded view of present invention for showing the raised pillars as detachable from the lighting base.

Said figures show said raised pillars (11) are placed on the top surface of the lighting base (1), forming raised pillars which is formed in one piece that is also detachable from the lighting base.

Also, the top surface of said lighting base (1) has holes (12) inserted to fit said detachable raised pillars.

Through the raised pillars (11) can be selected for integrally formed with or detachable from the lighting base, business dealers can make choices by judging the thickness of the circuit board (2), thus, making the application uses of the present invention more divisive.

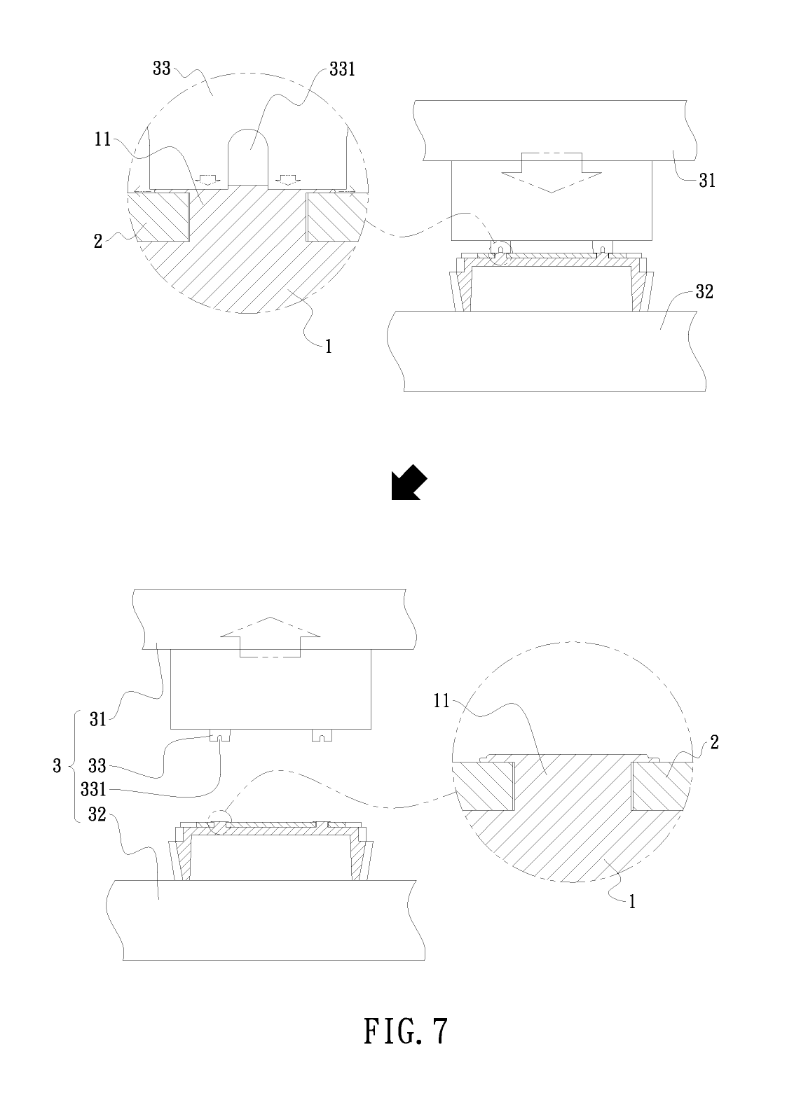

As shown in FIGS. 6 & 7 are cutaway motion diagrams depicting the invention's lighting base matching up with the mold.

Said figures show that, as a mold used for stamping LED Lamps' lighting bases that is suitable with said LED Lamp's lighting base, its features are as follows:

The Top Mold part (31) has one side that coordinates with said raised pillars' (11) part and includes mold cores (33) that can stamp the raised pillars. The mold cores (33) also have fillisters (331) at the bottom.

The Bottom Mold part (32) can coordinate with the Top Mold part (31) to store the lighting base (1).

Through the stamping of said raised pillars (11) by the multiple mold cores (33) extended from the Top Mold part (31), said raised pillars (11) are able to be riveted on the side surroundings of the circuit board's (2) vents (21) through the multiple mold cores (33) extended from the Top Mold part (31), resulting in said lighting base (1) being tightly riveted through the raised pillars (11) and circuit board (2).

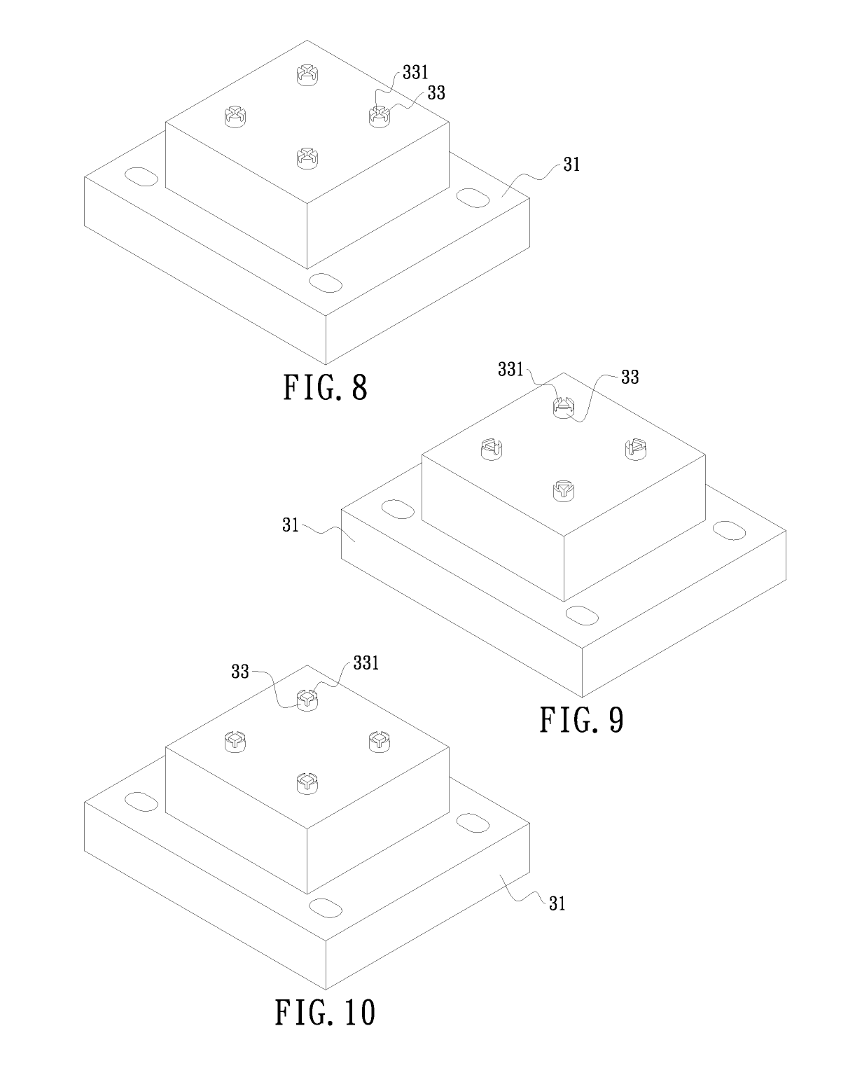

As shown in FIGS. 8˜10 are 3-D diagrams showing the various shapes of the invention's mold core's fillisters.

As described before, the shape of said fillisters (331) can be either one of the Following: a triangle, a polygon, or a cross.

Through the shape of the mold core's (33) fillisters (331) can be choosed from one of the following: a triangle, a polygon, or a cross, which can diversify the applications of the present invention while forming different product segmentations to expand the business dealers' market.

Through the detailed descriptions from the drawings, we can know the positive effect of present invention is to avoid the LED Lamps from electric leakage problems caused by the circuit board's loosening and damage from long continuing use.

Combing all that is described above, which is shown that through the coordinated applications of the lighting base's (1) raised pillars, the circuit board's (2) vents (21) and the mold cores (33) of the Top Mold part, the present invention can avoid the LED Lamps from electric leakage problems caused by the circuit board's loosening and damage from long continuing use.

What are disclosed above are only the preferred embodiments of the present invention and it is therefore not intended that the present invention be limited to particular embodiments disclosed. It will be understood by those skilled in the art that various equivalent changes may be made depending on what is claimed hereafter without departing from the scope of the present invention.

What is claimed is:

1. A lighting base of LED Lamp and its stamping mold, wherein said lighting base is characterized in that:
The top surface of the lighting base (1) is surrounded with several axial-protruding raised pillars (11), with a circuit board (2) placed on the top of the lighting base (1). This circuit board (2) is equipped with vents (21) that can tit tightly with the raised pillars (11), and the raised pillars (11) can fit tightly with the vents (21) after being squeezed from stamping through the mold (3), preventing the circuit board (2) from loosening and detached from the lighting base (1) as foresaid.

2. A lighting base (1) of LED Lamp of claim 1, wherein said circuit board (2) is inserted with at least one or more Light-Emitting Diodes (4) that are electrically connected with said circuit board (2).

3. A lighting base (1) of LED Lamp of claim 1, wherein said raised pillars (11) are placed on the top surface of the lighting base and formed in one piece, which is also detachable from said lighting base.

4. The lighting base of the LED Lamp of claim 1, wherein the top surface of said lighting base (1) has holes (12) inserted to fit said detachable raised pillars (11).

5. A lighting base of LED Lamp and its stamping mold, wherein said stamping mold is comprising:
A Top Mold part (31);
A Bottom Mold part (32);
Said top mold part (31) has one side that coordinates with said raised pillars' part and includes a mold core that can stamp the raised pillars. The mold cores (33) also has fillisters (331) at the bottom;
Said bottom mold part (32) can coordinate with the Top Mold part (31) to store the lighting base (1) of the LED lamp.

6. A stamping mold of claim 5, wherein the shape of said fillisters (331) can be either one of the following: a triangle, a polygon, or a cross.
